(19) United States
(12) Patent Application Publication
(10) Pub. No.: US 2014/0303279 A1
(43) Pub. Date: Oct. 9, 2014

(54) ENHANCED DEGRADATION OF POLYMERIC MATERIALS VIA SOLID-STATE SHEAR PULVERIZATION

(71) Applicants: Philip J. Brunner, South Milwaukee, WI (US); John M. Torkelson, Skokie, IL (US)

(72) Inventors: Philip J. Brunner, South Milwaukee, WI (US); John M. Torkelson, Skokie, IL (US)

(73) Assignee: Northwestern University, Evanston, IL (US)

(21) Appl. No.: 14/206,291

(22) Filed: Mar. 12, 2014

Related U.S. Application Data
(60) Provisional application No. 61/781,425, filed on Mar. 14, 2013.
(60) Provisional application No. 61/777,827, filed on Mar. 12, 2013.

(51) Int. Cl. C08J 3/20

(52) U.S. Cl. CPC C08J 3/203
USPC 523/126

(57) ABSTRACT

Solid-state shear pulverization, as can be used to disperse a pro-oxidant component in a polymer component and affect subsequent polymer biodegradation.

This application claims priority benefit from application Ser. No. 61/781,425 filed Mar. 14, 2013 and application Ser. No. 61/777,827 filed Mar. 12, 2013—each of which is incorporated herein by reference in its entirety.

This invention was made with government support under grant number CMMI-0820993 awarded by the National Science Foundation. The government has certain rights in the invention.

### BACKGROUND OF THE INVENTION

The annual world production of plastics, which was around 0.5 million tons in 1950, surpassed 230 million tons in 2009. Although plastics have many valuable uses, the increase in production has also led to a major escalation in plastic waste in the natural environment. A majority of these materials will require several hundreds to even thousands of years to ultimately degrade. Of these non-degradable plastics, polyolefins, such as polyethylene (PE), are the most heavily processed because of their exceptional mechanical properties and low cost, allowing them to be used for a large number of industrial applications, especially related to agriculture and packaging. However, any application typically involves only single or short time usage, before disposal. Due to this ever increasing problem, there has been significant research toward a more eco-friendly, biodegradable PE.

It has been estimated that PE would degrade less than 0.5% in 100 years—and, only 1% even if exposed to sunlight for 2 years—before microbial degradation, i.e., biodegradation. There are several reasons why polyolefins, such as PE, are inert materials not susceptible to environmental breakdown. The long hydrophobic hydrocarbon polymer chains are highly resistant to hydrolysis. Addition of antioxidants and stabilizers during manufacture prevent polyolefins from undergoing atmospheric oxidation. With respect to biodegradation, high packing density and molecular weight leave the molecule inaccessible to intracellular enzyme systems, rendering the polymer resistant to microbial action.

Over the past two decades, several methods have been investigated for enhancing the degradation of polyolefins: among them blending with biodegradable, natural polymers such as cellulose or starch, and isolating and improving microorganisms that can efficiently degrade such polymers. In particular, for degradation of PE, the use of pro-oxidants has gained much attention. (See, e.g., Koutny, M., Lemaire, J., & Delort, A. M. (2006). Biodegradation of polyethylene films with prooxidant additives. Chemosphere, 64(8), 1243-1252.) Typically, pro-oxidants are transition metal ion complexes that are added to polyolefins during processing in the form of fatty acid carboxylates or other organic ligand complexes. From a functional prospective, pro-oxidant additives act as initiators for thermo-or photo-oxidation leading to polymer chain fragmentation, a decrease in polymer molecular weight, and the formation of hydrophilic groups. (Fechine, G. J .M., Rosa, D. S., Rezende, M. E., & Demarquette, N. R. (2009). Effect of UV Radiation and Pro-Oxidant on PP Biodegradability. Polymer Engineering and Science, 49(1), 123-128.) With reduced molecular weight—for instance, less than ˜1000 g/mol—the oxidized products are then more susceptible to biodegradation, as the hydrocarbon backbones provide nutrients for the microorganisms.

The use of pro-oxidants to effectively initiate oxidation and ultimately produce degradable PE is promising. However, several issues must be addressed before such polymers are accepted as environmentally benign alternatives to their nondegradable equivalents. There is very little scientific evidence that these polymers are effectively biodegraded in a realistic time frame. Two factors can be related to degradation inefficiency. First, due to polarity differences, it is difficult to effectively disperse pro-oxidants during processing with a non-polar polymer, and as a result only those regions with pro-oxidant present undergo degradation. Second, the micro-organisms used for biodegradation are too large to diffuse through a plastic product. Again, as a result, degradation is limited as only the polymer fragments at or close to the surface are readily available for microbial attack. Accordingly, there remains an on-going search in the art to provide an approach to improve degradation rate and effectiveness for PE and a range of other polymeric materials.

### SUMMARY OF THE INVENTION

In light of the foregoing, it is an object of the present invention to provide a methodology for incorporation of pro-oxidant components into polyolefins and/or related methods for the degradation of such polymeric materials, thereby overcoming various deficiencies and shortcomings of the prior art, including those outlined above. It will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It can be an object of the present invention to provide a method of using solid-state shear pulverization (SSSP) for efficient and effective dispersion of a pro-oxidant component into any polymer type, e.g., polyolefins, polyesters, polyamides, epoxy, elastomers, etc., or combinations thereof., such dispersion without agglomeration.

It can be another object of this invention to provide one or more methods of SSSP to increase the surface area of a polymeric material available for microbial action and eventual degradation.

It can be another object of this invention, alone or in conjunction with one or more of the proceeding objectives, to provide a methodology enhancing polymer biodegradation.

Various other objects, features, benefits and advantages of this invention will be apparent from this summary and the descriptions of certain embodiments, and will be readily apparent to those skilled in the art having knowledge of various polymeric materials and techniques to promote their degradation. Such objects, features, benefits and advantages will be apparent from the above as taken into conjunction with the accompanying examples, data, figures and all reasonable inferences to be drawn therefrom, alone or with consideration of the references incorporated herein.

In part, the present invention can be directed to a method of dispersing or using, as described below, a solid-state shear pulverization apparatus to disperse a pro-oxidant component in a polymer component. Such a method can comprise providing a mixture comprising a polymeric component and a pro-oxidant component; and dispersing such a pro-oxidant component within the polymer component by applying a mechanical energy thereto through solid-state shear pulverization in the presence of cooling at least partially sufficient to maintain such polymer component in a solid state, such pulverization at least sufficient to provide a pulverization product substantially without agglomeration of such a pro-oxidant component therein. Optionally and in certain embodiments, such pulverization can be used in conjunction with a melt-mixing process of the prior art.

In certain embodiments, such a pro-oxidant component can be selected from but is not limited to a range of metal salts known in the art to promote polymer oxidation. In certain such embodiments, without limitation as to any one theory or mode of operation, useful pro-oxidant components can include various transition metal compounds, wherein the metal component has stable valence states separated by one oxidation number, with a low activation energy between the valence states. Counter anions and/or ligands can include stearates and related fatty acid carboxylates. Such pro-oxidant components can, without limitation, be selected from iron (Fe³⁺), manganese (Mn²⁺) and cobalt (Co²⁺) stearates. More generally and from a functional perspective, a pro-oxidant component is limited only by acceleration of, for any polymer type (e.g., polyolefins, polyesters, polyamides, acrylics, epoxides, thermoplastics, elastomers, etc., or combinations thereof), photo- and/or thermo-oxidation resulting in enhanced polymer susceptibility to biodegradation, such susceptibility as can be manifested by reduced molecular weight and/or formation of hydrophilic moieties on the polymer chain. Such pro-oxidant components are understood by those skilled in the art made aware of this invention. Regardless of pro-oxidant identity, whether or not a transition metal salt, such a component can comprise less than about 0.1 wt. % to about 2.0 wt. %, to about 5.0 wt. %, to about 10.0 wt. %, or to about 50.0 wt. % or more of a component mixture, such amount limited only by process considerations and that to effect a desired degree of polymer oxidation.

Likewise, without limitation, in certain embodiments, the polymer component can be selected from a range of virgin and recycled polymeric materials, whether described structurally or functionally, such a component as can be selected from but not limited to polyolefins, polyesters, polyamides, epoxides, thermoplastics, elastomers, etc., combinations thereof, and copolymers of such polymers, combinations of such copolymers, and combinations of such polymers and copolymers. In certain embodiments, a polyolefin component can be selected from a range of virgin and recycled polyethylene homo- and copolymers, virgin and recycled polypropylene homo- and copolymers and combinations of such polymers and/or copolymers. Without limitation, as illustrated below, such a polyolefin component can comprise low-density polyethylene.

In part, the present invention can also be directed to a method of affecting any polymer degradation. Such a method can comprise providing a mixture comprising a polymeric component and a pro-oxidant component; applying a mechanical energy to such a mixture through solid-state shear pulverization in the presence of cooling at least partially sufficient to maintain such a polymer in a solid state; and degrading such a pulverized mixture under at least one of temperature or light conditions sufficient to provide an oxidized polyolefin product. Polymer and pro-oxidant components can be as discussed above, described elsewhere herein or would otherwise be known to those skilled in the art made aware of this invention. Regardless, in certain embodiments, such a methodology can be used in conjunction with or without melt-mixing and/or biodegradation processes of the prior art.

In part, the present invention can also be directed to a method of increasing polymer surface area, to enhance biodegradation. Such a method can comprise providing a mixture comprising a polymer component and a pro-oxidant component; applying a mechanical energy to such a mixture through solid-state shear pulverization in the presence of cooling at least partially sufficient to maintain such a polymer component in a solid state, such a pulverization at least partially sufficient to provide a pulverization product comprising a pro-oxidant component dispersed therein; and oxidizing such a pulverization product under temperature and/or light conditions sufficient to lower average polyolefin molecular weight and increase polymer surface area. Again, polymer and pro-oxidant components can be as discussed above, described elsewhere herein or would otherwise be known to those skilled in the art made aware of this invention.

In part, the present invention can also be directed to a polymer composition comprising any polymer type, e.g., polyolefins, polyesters, polyamides, epoxy, elastomers, etc., or combinations thereof, and a pro-oxidant component dispersed therein, such a composition as can be substantially absent pro-oxidant agglomeration. In certain embodiments, as discussed elsewhere herein, such a polymer component can be selected from various polyolefins, polyesters, polyamides, epoxy, elastomers, etc., and or combinations thereof and/or copolymers of such components. Pro-oxidant content is limited only by an amount sufficient to at least partially promote or initiate a desired degree of thermo- and/or photo-oxidation. Without limitation as to polymer component or pro-oxidant content, such a composition can be incorporated into an article of manufacture.

In certain non-limiting embodiments, such a polymer composition can comprise a polyethylene component and a transition metal salt of a fatty acid dispersed therein, such a composition as can be the solid-state shear pulverization product of a polyethylene pro-oxidant mixture. Such a pro-oxidant component can be as described above, discussed or inferred elsewhere herein or as would otherwise be understood by those skilled in the art made aware of this invention. Regardless, the pro-oxidant content of such a composition can be considered in the context of desired polymer degradation and/or resulting oxidized polyethylene products, such content as can range from less than about 0.1 wt. % to about 50.0 wt. % or more of the polymer composition.

### BRIEF DESCRIPTION OF THE DRAWINGS

FIG. 1 is a schematic illustration of a solid-state shear pulverization (SSSP) apparatus of the sort useful in conjunction with the present invention.

FIG. 2A-B. Digital images of compression molded disks of LDPE+1 wt % cobalt stearate produced via A) melt-processing, only; and B) two-step SSSP/melt-processing (MP) technique. It is shown that large agglomerates remain in melt-processed only materials whereas excellent dispersion and break-up of agglomerates is observed in SSSP/MP samples.

FIG. 3. Elongation at break as a function of time for neat LDPE (diamonds) and LDPE+1 wt. % cobalt stearate produced via MP (squares) and two-step SSSP/MP (triangles) at an oxidation temperature of 56° C.

### DETAILED DESCRIPTION OF CERTAIN EMBODIMENTS

As illustrated by several non-limiting embodiments, this invention provides a continuous, environmentally-benign approach to effectively and efficiently break-up and disperse various pro-oxidant additives in polymeric materials. Through effective pro-oxidant dispersion, the rate of polymer degradation can be dramatically increased. Generally, pulverization can be accomplished in an SSSP apparatus of the sort described herein or would otherwise be known in the art, such apparatus, component construction, screw elements, transport elements, kneading or shearing elements, and spacer elements and/or the sequence or design thereof can be selected or varied as required to accommodate a particular polymer starting material, pulverization parameters and/or pulverized polymer product. Such apparatus, components and operation are understood by those skilled in the art and, for instance, can be of the sort described more fully in U.S. Pat. Nos. 5,814,673; 6,180,685 and 7,223,359—each of which is incorporated herein by reference in its entirety.

A significant difference between the SSSP technology utilized in conjunction with this invention and a conventional twin-screw melt extruder is a cooling system that effectively circulates a coolant throughout the apparatus during operation. This coolant removes the heat generated during operation, which allows for processing in the solid-state. The shear and compressive forces applied during operation are much greater than a conventional extruder; therefore, SSSP allows for excellent break-up and dispersion of additives in the polymer matrix. Relating to pro-oxidant dispersion, major advantages over conventional techniques include:
Improved dispersion of pro-oxidants in polymer matrix;
Increased surface area for biodegradation; and
Elimination of one heat cycle, preventing degradation of heat sensitive polymers during compounding step.

Other advantages of SSSP over conventional processes like solvent casting, in-situ polymerization, and melt processing include the following:
Overcoming the limitations of thermodynamics, viscosity, and degradation often encountered in melt processing of polymers;
Elimination of the use of hazardous solvents, which is a major requirement in achieving sustainability and promoting green chemistry;
Versatility in adjusting screw design, screw speed, and zone temperatures, which all play major roles in adjusting the amount of work applied to the material during processing;
Continuous, industrially scalable, and high throughput processing, which is advantageous over batch solid-state processing techniques like ball-milling;
Economic feasibility;
Low maintenance, easy to clean apparatus, and simple operation; and
Overcoming low thermal stability often encountered in the production of materials since mixing takes place at ambient temperatures, whereas processing of these materials above Tₘ leads polymer degradation and reduction in physical properties.

### Examples of the Invention

The following non-limiting examples and data illustrate various aspects and features relating to the methods and/or compositions of the present invention, including the preparation of various biodegradable polyolefin materials, as are available through the methodologies described herein. In comparison with the prior art, the present invention provides results and data which are surprising, unexpected and contrary thereto. While the utility of this invention is illustrated through the use of several representative apparatus configurations, polyolefin starting materials and pro-oxidant components processed therewith, it will be understood by those skilled in the art that comparable results are obtainable with various other apparatus configurations, polymers and pro-oxidants incorporated therewith, as are commensurate with the scope of this invention.

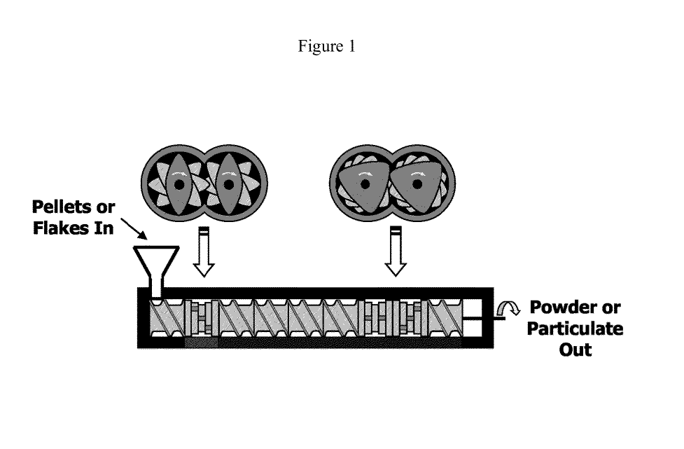

The SSSP process employed is a modified twin-screw extruder from Berstorff (Model ZE 25). It has a length to diameter ratio (L/D) of 26.5, where the first section has a barrel/screw diameter of 25 mm (L/D=19) and remaining section has a diameter of 23 mm (L/D=7.5). The screw elements involved in the 25 mm-section are spiral conveying and bilobe kneading elements, while those in the 23 mm-section are trilobe shearing elements. During operation, the barrels are cooled by a recirculating ethylene glycol/water (60/40 wt/wt) mixture at −7° C. supplied by a Budzar Industries WC-3 chiller, which allows for repeated fragmentation and fusion steps in the solid-state below the glass transition (T_{g}) or melt transition (Tₘ) of the processed polymeric material. For this pulverization instrument, the barrel section with several kneading elements in the upstream portion of the screws is termed the mixing zone. A long conveying zone follows the mixing zone to sufficiently cool the deformed material before intense pulverization takes place downstream in the pulverization zone. The use of SSSP will lead to the development of more sustainable and energy efficient polymeric materials that cannot be developed using conventional polymer processing methods. An apparatus useful in conjunction with the present invention is illustrated in co-pending application Ser. No. 12/566,342 filed Sep. 24, 2009. (See, e.g., FIG. 1.)

### Example 1

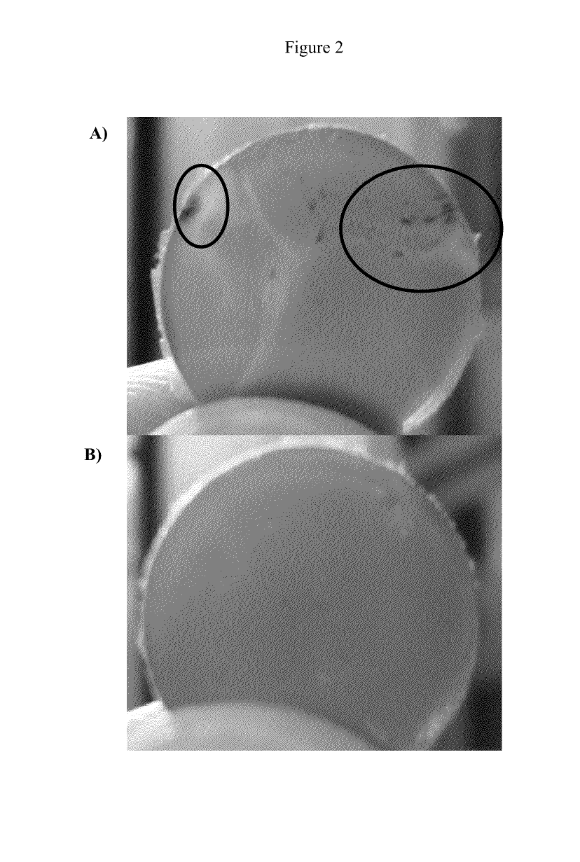

In a preliminary study, it was found that SSSP processing can effectively disperse pro-oxidant materials in low-density PE (LDPE). FIGS. 2A and 2B provide digital images of compression molded disks of LDPE+1 wt % cobalt stearate (CS) produced via melt-processing (MP) only, and a two-step SSSP/MP technique, respectively. From FIG. 2A, it is evident that the CS particles remain highly agglomerated following MP, whereas in FIG. 2B these agglomerated regions are absent. This suggests that SSSP processing, in accordance with this invention, can effectively break up pro-oxidant agglomerates with simultaneous dispersion throughout the LDPE matrix.

### Example 2

To extend the utility demonstrated in Example 1, a pro-oxidant component such as cobalt stearate is mixed with virgin polypropylene and shear pulverized in the solid state, to provide a corresponding pulverization product absent pro-oxidant agglomeration.

### Example 3

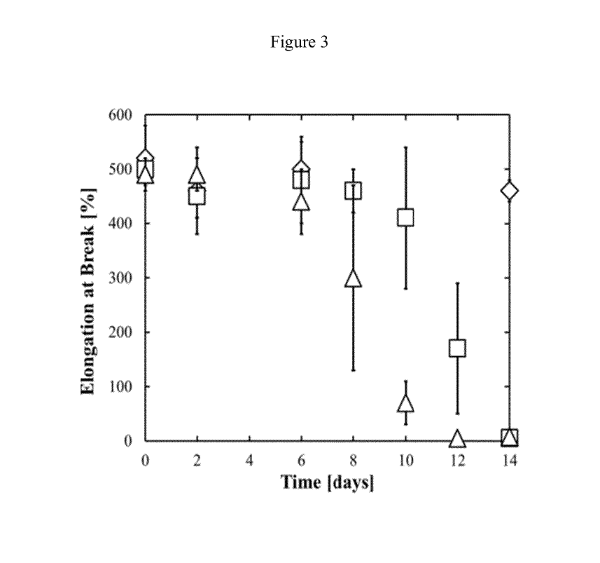

The enhanced dispersion and break-up of the pro-oxidant agglomerates in LDPE following the two-step SSSP/MP technique also leads to a faster rate of thermo-oxidative degradation and greater molecular weight (M) reduction. In FIG. 3, elongation at break (ε_{B}) is shown as a function of time for materials subjected to thermo-oxidation at 56° C. It has been previously established that the ε_{B} of a polymer dramatically decreases as its weight average molecular weight (M_{w}) approaches the entanglement molecular weight (Mₑ) . (See, Mccormick, H. W., Brower, F. M., & Kin, L. (1959). The Effect of Molecular Weight Distribution on the Physical Properties of Polystyrene. Journal of Polymer Science, 39(135), 87-100.) Under an applied load, chains with M_{w}<Mₑ, can pull out from one another and cause localized crazing, ultimately leading to brittle fracture. In contrast, when M_{w}>10 Mₑ, the ε_{B} of becomes relatively constant, and exhibits ductile behavior. The results from this study suggest that degradation and thus significant M_{w} reductions begin at ˜10 and ˜7 days for the materials produced via MP only and the two-step SSSP/MP technique, respectively. This is a significant difference and suggests that SSSP processing prior to MP can lead to major enhancements in the LDPE degradation rate.

### Example 4

This invention can also be used in conjunction with various polymer materials such as those described in U.S. Pat. No. 6,797,216, the entirety of which is incorporated herein by reference. For instance, as would be understood by those skilled in the art and made aware of this invention, various amounts and/or proportions of post-consumer/post-industrial polymeric scrap material, virgin material, and blends thereof (e.g., binary, ternary, and quaternary, etc. blends of different polymers or a polymer from multiple sources), as illustrated in the '216 Patent, can be processed with a pro-oxidant component in accordance with one or more embodiments of the present methodology using an apparatus and/or under conditions of the sort described in the '216 Patent or elsewhere herein.

### Example 4a

Chopped polypropylene (PP), high-density polyethylene (HDPE) or low-density polyethylene (LDPE) scrap flakes, as described in the '216 Patent (e.g., examples 1-3 thereof), can be used in conjunction with the present methodology without undue experimentation.

### Example 4b

Blends of chopped HDPE, LDPE, and PP scrap material, as described in the '216 Patent (e.g., example 4 thereof), can be used in conjunction with the present methodology without undue experimentation.

### Example 4c

Blends of chopped HDPE and PP scrap flakes, as described in the '216 Patent (e.g., examples 5 and 6 thereof), can be used in conjunction with the present methodology without undue experimentation.

### Example 4d

Blends of chopped HDPE and LDPE scrap flakes, as described in the '216 Patent (e.g., example 7 thereof), can be used in conjunction with the present methodology without undue experimentation.

### Example 4e

Various blends of LDPE scrap flakes and virgin LDPE material, as described in the '216 Patent (e.g., Table IV thereof), can be used in conjunction with the present methodology without undue experimentation.

### Example 5

Compositions of homopolymeric and/or copolymeric materials and/or blends of virgin and/or recycled homopolymers and/or copolymers can be prepared with pro-oxidant component(s) as described herein. In particular, representative of various other embodiments of this invention, polyesters such as polyethylene terephthalate (PET) and polyhydroxybutyrate (PHB) can be used alone, in combination one with another and/or with one or more polyolefins, depending on desired end-use properties of a resulting pulverization product or article incorporating such a product. (See e.g., Table 1, below.)

TABLE 1
Compositions of homopolymer and polymer blends of virgin
and/or recycled materials with pro-oxidant components

| | Virgin | Recycle | Virgin | Recycle | Virgin | Recycle | Cobalt | a Cobalt | Iron |
|---|---|---|---|---|---|---|---|---|---|
| | LDPE | LDPE | PET | PET | PHB | PHB | Stearate | Carboxylate | Stearate |
| Material | (wt %) | (wt %) | (wt %) | (wt %) | (wt %) | (wt %) | (wt %) | (wt %) | (wt %) |
| Sample 1 | 95 | 0 | 0 | 0 | 0 | 0 | 5 | 0 | 0 |
| Sample 2 | 90 | 5 | 0 | 0 | 0 | 0 | 0 | 0 | 5 |
| Sample 3 | 5 | 85 | 5 | 0 | 0 | 0 | 0 | 5 | 0 |
| Sample 4 | 0 | 0 | 90 | 0 | 5 | 0 | 0 | 0 | 5 |
| Sample 5 | 0 | 0 | 5 | 85 | 5 | 0 | 5 | 0 | 0 |
| Sample 6 | 0 | 0 | 0 | 0 | 90 | 5 | 0 | 0 | 5 |
| Sample 7 | 0 | 0 | 85 | 0 | 0 | 0 | 5 | 5 | 5 |
| Sample 8 | 0 | 5 | 0 | 5 | 0 | 80 | 0 | 5 | 5 |
| Sample 9 | 0 | 0 | 0 | 0 | 95 | 0 | 0 | 0 | 5 |
| Sample 10 | 5 | 5 | 5 | 5 | 5 | 60 | 5 | 5 | 5 |
| Sample 11 | 85 | 0 | 0 | 0 | 0 | 0 | 5 | 5 | 5 |
| Sample 12 | 10 | 75 | 0 | 0 | 5 | 0 | 5 | 5 | 0 |
| Sample 13 | 0 | 0 | 5 | 90 | 0 | 0 | 0 | 0 | 5 |
| Sample 14 | 0 | 0 | 10 | 0 | 75 | 5 | 5 | 0 | 5 |
| Sample 15 | 0 | 0 | 0 | 0 | 0 | 95 | 0 | 5 | 0 |

We claim:

1. A method of dispersing a pro-oxidant component in a polymer, said method comprising:
providing a mixture comprising a low-density polyethylene polymer component and a cobalt stearate pro-oxidant component; and
applying a mechanical energy to said mixture through solid-state shear pulverization in the presence of cooling at least partially sufficient to maintain said mixture in a solid state during said pulverization, said pulverization at least partially sufficient to provide a pulverization product substantially absent agglomeration of said pro-oxidant component.
